(19) United States
(12) Patent Application Publication
(10) Pub. No.: US 2008/0235234 A1
(43) Pub. Date: Sep. 25, 2008

(54) ACCESS CONTROL LIST (ACL) BINDING IN A DATA PROCESSING SYSTEM

(75) Inventors: Ganesha BEEDUBAIL, Fremont, CA (US); Ramakrishna Dwivedula, San Jose, CA (US); Ganesh Vaideeswaran, San Jose, CA (US)

Correspondence Address: SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 12/133,506

(22) Filed: Jun. 5, 2008

Related U.S. Application Data
(63) Continuation of application No. 11/254,399, filed on Oct. 20, 2005.

(51) Int. Cl. G06F 17/30

(52) U.S. Cl. 707/9; 707/E17.005

(57) ABSTRACT

Systems for updating an access control list (ACL) associated with one or more resources in a data processing system are provided. The system provides a table including a list of one or more first ACLs that map to a corresponding one or more previously computed second ACLs. The system also updates a current ACL associated with a first resource of the one or more resources in the data processing system including determining whether one of the one or more first ACLs in the table matches the current ACL associated with the first resource. If one of the one or more first ACLs in the table matches the current ACL associated with the first resource then updating the current ACL associated with the first resource by associating the corresponding second ACL with the first resource.

### CROSS-REFERENCE TO RELATED APPLICATIONS

Under 35 USC §120, this application is a continuation application and claims the benefit of priority to U.S. patent application Ser. No. 11/254,399, filed Oct. 20, 2005, entitled “Method for Access Control List (ACL) Binding in a Data Processing System,” which is incorporated herein by reference.

### FIELD OF THE INVENTION

The present invention relates generally to data processing systems, and methods for controlling access to data within data processing systems.

### BACKGROUND OF THE INVENTION

Data, in general, can be manipulated in many ways in a data processing system. For example, data can be accessed, encoded, communicated, converted, entered, filed, linked, and mapped in a data processing system. Due to large amounts of data that can be available to users of data processing systems and the wide variety of interactions such users may require with data, management of data within data processing systems is typically required by, e.g., a network administrator or system operator.

In the course of managing large amounts of data, network administrators typically limit authorizations or permissions of users to certain data within a data processing system. For example, a network administrator may desire to limit access of particular users (or groups of users) to certain storage devices, directories, or files within a data processing system to, e.g., prevent unauthorized use of sensitive data, or to prevent damage to the data processing system through inadvertent alteration or deletion of data or other files. Examples of authorizations or permissions of users include authority to read, write, or execute files, data, or directories, to modify permissions, and the like.

An access control list (ACL) is normally used to protect (or control the access to) resources (e.g., data, files, or objects) in a data processing system. Generally, ACLs identify which users may access an object such as a file or directory, and identify the type of access that a user has for a particular object. A network manager or system operator may alter such ACLs to change what data a user may have access to, the type of access available, and operations which the user is authorized to perform on accessed data. Example systems that employ ACLs are “file systems” in operating systems such as Windows2000 NTFS (where files and directories are protected using ACLs), and “content management systems” such as the JCR lava content repository) (JSR-170) in the application domain.

Resources (e.g., data, files, or objects) in data processing systems are typically organized in a hierarchical tree structure. In this hierarchical environment, an ACL can be (logically) attached to a resource—e.g., a file or a document. ACLs typically consist of a list of access control entries (ACEs). Each ACE specifies, a user (or a group of users) and the allowed access type. In addition, in a hierarchical environment, “ACE inheritance” generally occurs—i.e., if an ACE is added to an ACL of a parent resource, the effect of the ACE is (optionally) visible to all the children of the parent resource. Two conventional methods for performing ACE inheritance include dynamic ACL binding and static ACL binding.

According to dynamic ACL binding an ACE (and ACL) is maintained at a parent resource. At the time of determining a user's access to a child resource (of the parent resource), the tree hierarchy is traversed up to the parent resource and the effective ACL for the child resource, and the permission of the user to access the child resource, is determined. Dynamic ACL binding generally provides good performance in terms of modifying an ACL, however, dynamic ACL binding typically requires substantial processing time in order to compute a new ACL for each child resource (at the time of determining a user's access to a resource).

According to static ACL binding when an ACE or ACL is modified at a parent resource, the ACE or ACL modification is also propagated to all the children resources of the parent resource. That is, for each child resource, the effective ACL for a given child resources is computed and stored (or logically attached) with the given child resource. Static ACL binding provides good performance at the time of determining a user's access to a resource; however, such a binding technique generally requires substantial processing time to compute a new ACL for each child resource at the time of ACE or ACL modification.

Accordingly, both dynamic ACL binding and static ACL binding have some drawbacks. However, static ACL binding generally provides a better fit for most systems that require scalability. Note that, generally, modifications to an ACL (of a parent resource) are relatively less frequent compared to “access checks” of a resource.

Accordingly, what is needed is a system and method for providing an efficient algorithm for performing static ACL binding—i.e., propagating an ACE or ACL modification through a tree hierarchy of resources. The present invention addresses such a need.

### BRIEF SUMMARY OF THE INVENTION

In general, in one aspect, this specification describes a method for updating an access control list (ACL) associated with one or more resources in a data processing system. The method includes providing a table including a list of one or more first access control lists (ACLs) that map to a corresponding one or more previously computed second access control lists (ACLs); and updating a current access control list (ACL) associated with a first resource of the one or more resources in the data processing system including determining whether one of the one or more first access control lists (ACLs) in the table corresponds to the current access control list (ACL) associated with the first resource. If one of the one or more first access control lists (ACLs) in the table corresponds to the current access control list (ACL) associated with the first resource then updating the current access control list (ACL) associated with the first resource by associating the corresponding second access control list (ACL) with the first resource.

Particular implementations can include one or more of the following features. If one of the one or more first access control lists (ACLs) in the table does not match the current access control list (ACL) associated with the first resource then the method can further include computing a new access control list (ACL) for the first resource, and adding an entry to the table that maps the current access control list (ACL) with the newly computed access control list (ACL). An access control list (ACL) can identify which users may access a given resource within the data processing system and can identify a type of access that the users have for the given resource. The one or more resources in the data processing system can be organized in a hierarchical tree structure. The data processing system can include a workstation, a desktop computer, a laptop computer, a personal digital assistant (PDA), or a cell phone. Each first access control list (ACL) and second access control list (ACL) can include a unique ACL identifier (ACLid). Updating a current access control list (ACL) associated with a first resource in the data processing system can include receiving a new access control entry (ACE) for the first resource. The access control entry (ACE) can specify a user or a group of users and an allowed access type for the user or the group of users. The one or more resources in the data processing system can include a data, a file, or an object.

In general, in another aspect, this specification describes a computer program product, tangibly stored on a computer-readable medium, for updating an access control list (ACL) associated with one or more resources in a data processing system. The product comprises instructions to cause a programmable processor to provide a table including a list of one or more first access control lists (ACLs) that map to a corresponding one or more second access control lists (ACLs), in which the one or more second access control lists (ACLs) have been previously computed. The product further comprises instructions to update a current access control list (ACL) associated with a first resource of the one or more resources in the data processing system including determining whether one of the one or more first access control lists (ACLs) in the table corresponds to the current access control list (ACL) associated with the first resource. If one of the one or more first access control lists (ACLs) in the table corresponds to the current access control list (ACL) associated with the first resource then the product includes instructions to update the current access control list (ACL) associated with the first resource by associating the corresponding second access control list (ACL) with the first resource.

In general, in another aspect, this specification describes a data processing system including a table having a list of one or more first access control lists (ACLs) that map to a corresponding one or more second access control lists (ACLs), in which the one or more second access control lists (ACLs) have been previously computed. The data processing system further includes a file system operable to update a current access control list (ACL) associated with a first resource of the one or more resources in the data processing system including determining whether one of the one or more first access control lists (ACLs) in the table corresponds to the current access control list (ACL) associated with the first resource. If one of the one or more first access control lists (ACLs) in the table corresponds to the current access control list (ACL) associated with the first resource then the file system is operable to update the current access control list (ACL) associated with the first resource by associating the corresponding second access control list (ACL) with the first resource.

Implementations may provide one or more of the following advantages. An efficient algorithm for performing static ACL binding is provided. The algorithm removes the bottleneck associated with having to compute a new effective ACL for a child resource when appropriate. Accordingly, processing time required to compute a new effective ACL for child resources of a parent resource is substantially reduced. In addition, less main memory (of a computer system) is required to perform the efficient algorithm as compared to conventional static ACL binding techniques.

The details of one or more implementations are set forth in the accompanying drawings and the description below. Other features and advantages will be apparent from the description and drawings, and from the claims.

### BRIEF DESCRIPTION OF SEVERAL VIEWS OF THE DRAWINGS

FIG. 1 is a block diagram of a data processing system in accordance with one implementation of the invention.

FIG. 2 is a block diagram illustrating a hierarchical database of objects stored in the data processing system of FIG. 1 in accordance with one implementation of the invention.

FIG. 3 illustrates an ACL map table in the data processing system of FIG. 1 in accordance with one implementation of the invention.

FIG. 4 illustrates a method for performing static ACL binding in accordance with one implementation of the invention.

Like reference symbols in the various drawings indicate like elements.

### DETAILED DESCRIPTION OF THE INVENTION

Implementations of the present invention relates generally to data processing systems, and methods for controlling access to data within data processing systems. The following description is presented to enable one of ordinary skill in the art to make and use the invention and is provided in the context of a patent application and its requirements. Various modifications to implementations and the generic principles and features described herein will be readily apparent to those skilled in the art. Thus, the present invention is not intended to be limited to the implementations shown but is to be accorded the widest scope consistent with the principles and features described herein.

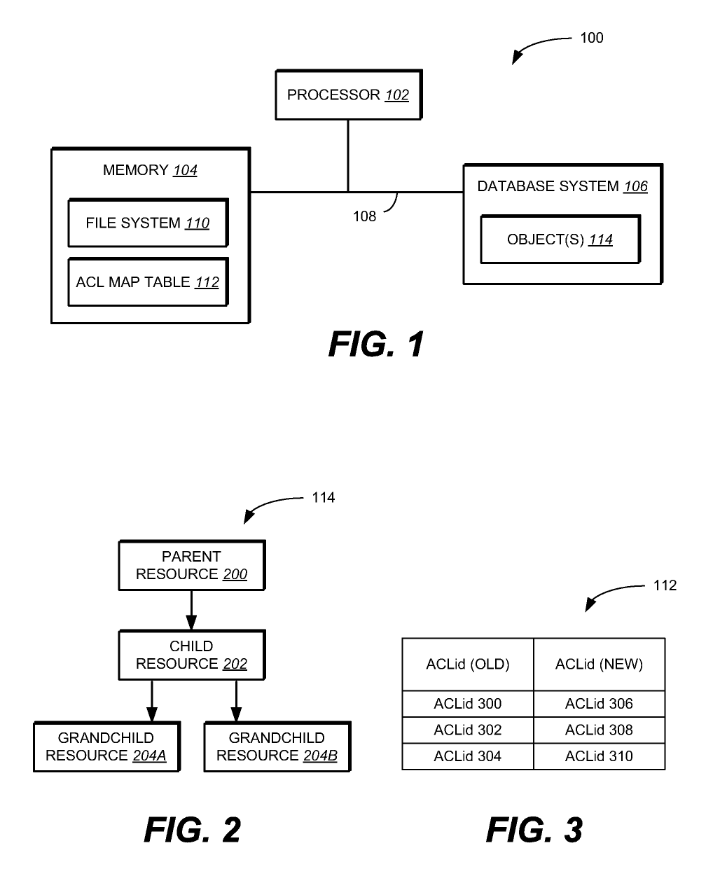

FIG. 1 illustrates a data processing system 100 in accordance with one implementation of the invention. Data processing system 100 includes a processor 102, a memory 104, and a database system 106 connected by a communication bus 108. Data processing system 100 can be any type of computer system, including for example, a workstation, a desktop computer, a laptop computer, a personal digital assistant (PDA), a cell phone, and so on. In general, during operation of data processing system 100, processor 102 processes data stored in memory 104 using computer program instructions also stored in memory 104. The data stored in memory 104 can be a part of a larger collection of organized data stored in database system 106.

Memory 104 includes a file system 110 and an ACL map table 112. File system 110 includes one or more ACLs (not shown). Each ACL can include a directory, a user and a permission. An ACL is a list of access control entries (or ACEs) or equivalently a list of users (or user groups) and their permissions to an object or container object, such as object(s) 114 in database system 106. A single ACE is one such user/group permission pair. Users can be combined into a group and inherit their permissions through the group rather than explicitly by a user. Various types of permissions may be granted to a user directly or through a group, such as, for example, delete (may delete object), execute (may execute object), read (may read object), write (may change object), create (may create new objects), permissions (may change ACL of object), attributes (may change attributes other than ACL), and the like. An ACL may be associated with each directory, file, printer or other resource in data processing system 100. In one implementation, each ACL is independently identifiable by an ACL identifier (ACLid).

Referring to FIG. 2, a hierarchical relationship of object(s) 114 (within database system 106) (according to one implementation) is illustrated. The hierarchy is organized in a tree structure, with familiar relationships such as “parent”, “child”, “grandchild”, and so forth. In this example, parent resource 200 is the root of the tree, and is the parent of child resource 202. Parent resource 200 is also the grandparent of grandchild resources 204A, 204B. Though parent resource 200 is shown as having one child and two grandchildren, parent resource 200 can have a different number of children and grandchildren, and/or additional descendants and siblings. In one implementation, each resource 200, 202, 204A, 204B includes a pointer to an ACL contained within file system 110.

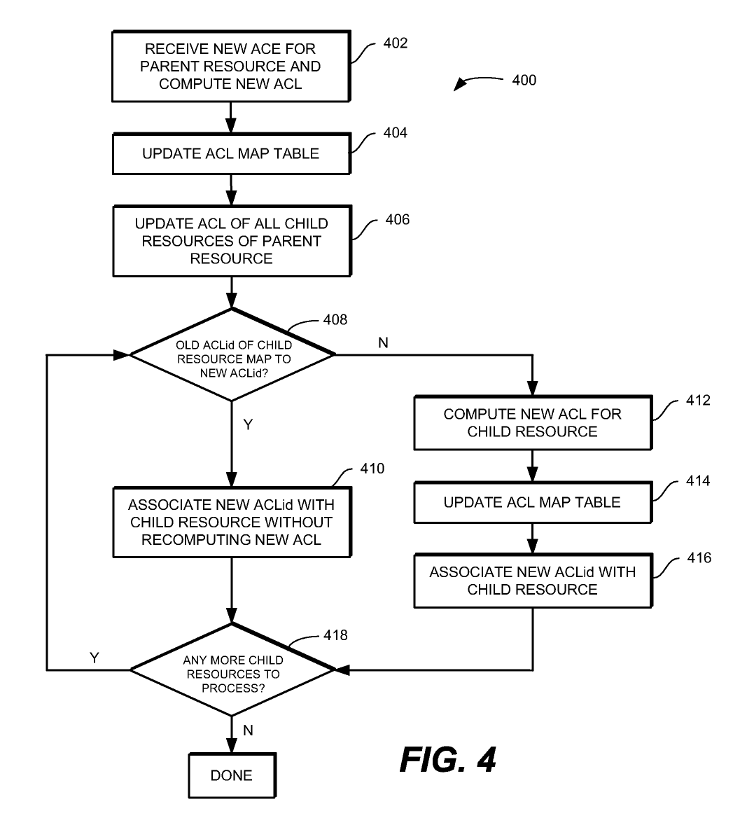

Referring back to FIG. 1, ACL map table 112 includes a list of old (or current) ACLs that map directly to a new ACL. In one implementation, ACL map table 112 is used to update an ACL of one or more resources (or object(s) 114) within database system 106 in accordance with static ACL binding techniques, as described in greater detail below in connection with FIG. 4. FIG. 3 illustrates one implementation of ACL map 112. As shown in FIG. 3, ACL map table 112 includes a column of old (or current) ACLids which map to a new ACLid. Specifically, old ACLid 300 maps to new ACLid 306, old ACLid 302 maps to new ACLid 308, and old ACLid 304 maps to new ACLid 310.

FIG. 4 illustrates a method 400 for performing static ACL binding in accordance with one implementation of the invention. A new ACE is received for a parent resource (e.g., parent resource 200) and a new ACL is computed (e.g., using an appropriate algorithm) for the parent resource (step 402). A new ACE for the parent resource can be received, for example, by a network administrator either adding or removing an ACE associated with the parent resource. After the new ACL for the parent resource is computed, an ACL map table (e.g., ACL map table 112) is updated (step 404). In one implementation, the ACL map table is updated to indicate that the old ACLid (associated with the old ACL of the parent resource) maps to the newly computed ACLid associated with the new ACL of the parent resource. The ACL of all child resources of the parent resource (e.g., child resource 202, and grandchild resources 204A, 204B) are updated (step 406). In one implementation, the child resources of the parent resource are updated in accordance with static ACL binding techniques as discussed in greater detail below.

For each child resource, a determination is first made as to whether the ACL map table includes an entry that indicates the current (or old) ACL of the child resource maps to a previously computed (or new) ACL (step 408). In one implementation, the determination is made by searching an old ACLid column associated with the ACL map table for an ACLid that corresponds to (e.g., matches) the current ACLid of the child resource. If the ACL map table includes an entry that does match and indicate that the current (or old) ACL of the child resource maps to a previously computed (or new) ACL, then the new ACL (ACLid) is associated with the child resource without having to recompute the new ACL (step 410). Accordingly, processing time associated with static ACL binding can be reduced unlike in conventional static ACL binding techniques. If the ACL map table does not contain an entry that corresponds to (or matches) and indicates that the current (or old) ACL of the child resource maps to a previously computed (or new) ACL, then a new ACL (ACLid) is computed for the child resource (step 412). The ACL map table is updated (step 414). In one implementation, a new entry is added to the ACL map table which indicates that the old ACLid of the child resource maps to the newly computed ACLid. The newly computed ACLid is then associated with the child resource (step 416). A determination is made whether there are any additional child resources to process (step 418). If there are additional child resources to process, then method 400 returns to step 408. If there are no additional child resources to process, then method 400 ends.

The following pseudo code implements the techniques described above in connection with FIG. 4. The pseudo code assumes that the ACL update process starts by invoking the routine UpdateParentACL, and providing the resource identifier and the new ACE.

```
UpdateParentACL (Resource res, ACE ace)
{
        Hash Table ht=new HashTable( );
              //create a new hash table that will keep a “map” of old and new ACLs
        aclPold=res.getACL( ); // get the existing ac1 from the Parent resource
        aclPnew=computeNewAc1 (aclPold, ace);
              //compute the ACL using the old one and with the input ACE
              //this will require accessing the repository
              //note: aclPnew, and aclPold are identifiers for ACLs (ACLids)
        ht.add (aclPold, aclPnew);
              //add the ‘map’ for old and (its) new (equivalent) ACL pair
        res.setAcl(aclPnew);
        UpdateChildACL(res, ace, ht);
}
Update ChildACL (Resource res, ACE ace, HashTable ht)
{
        List childList=res.getAllImmediateChildren( );
        numChildren = childList.getSize( );
        for(count=0; count<numChildren; count++)
        {
              childRes=childList[count];
              aclCold=childRes.getAcl( );
              htAcl=ht.get(aclCold);
              //this checks in map whether we have already completed a required ACL
              if (htAcl != NULL) // We found the proper ACL for the child resource
              {
                      childRes.setAcl(htAcl);
              }
              else
              {
                      ac1Cnew=computeNewAcl (aclCold, ace);
                      childRes.setAcl (aclCnew);
                      ht.add (aclCold, aclCnew);
                      //update the ‘map’ with the new pair that can be used by other
                      child resources
              }
              UpdateChildACL(childRes, ace,ht); //Note the RECURSIVE call.
        }
}
```

Note that the pseudo code listed above is just an example.

One or more of method steps described above can be performed by one or more programmable processors executing a computer program to perform functions by operating on input data and generating output. Generally, the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Various implementations for updating an ACL within a hierarchical tree of objects have been described. Nevertheless, one or ordinary skill in the art will readily recognize that there that various modifications may be made to the implementations, and any variation would be within the spirit and scope of the present invention. For example, the steps of methods discussed above can be performed in a different order to achieve desirable results. Accordingly, many modifications may be made by one of ordinary skill in the art without departing from the spirit and scope of the following claims.

What is claimed is:

1. A data processing system comprising:
a processor;
a memory coupled to the processor;
a table comprising a list of one or more old ACLs that map to a corresponding one or more new ACLs, wherein the one or more new ACLs has been previously computed for a given resource, wherein each ACL is a list of access control entries (ACEs), wherein each ACE indicates a type of access that a given users has for the given resource, wherein each ACL comprises a unique ACL identifier (ACLid) for the given resource, wherein the one or more resources are organized in a hierarchical tree structure comprising one or more parent resources and one or more corresponding child resources, wherein an ACE of a given parent resource is visible to the corresponding child resources, and wherein the one or more resources comprise data, a file, or an object, wherein the processor is operable to:
receive a new ACE for a parent resource; and
compute a new ACL and corresponding ACLid for the parent resource;
a file system operable to:
update the table with the new ACL, new ACLid, new ACE, and an indication that the new ACL corresponds to an old ACL for the parent resource; and
update a current ACL associated with a child resource corresponding to the parent resource, the current ACL updating comprising:
determining whether one of the one or more old ACLs associated with the child resource corresponds to the new ACL of the parent resource;
if one of the one or more old ACLs corresponds to the current ACL, associating the corresponding new ACL with the child resource, wherein the current ACL updating further comprises receiving a new ACE for the child resource; and
if one of the one or more old ACLs in the table does not match the current ACL, computing a new ACL for the child resource and adding an entry to the table that maps the current ACL with the new ACL.

2. A computer program product, tangibly stored on a computer-readable medium, for updating an access control list (ACL) associated with one or more resources in a data processing system, the product comprising instructions to cause a programmable processor to:
provide a table including a list of one or more old ACLs that map to a corresponding one or more new ACLs, wherein the one or more new ACLs has been previously computed for a given resource, wherein each ACL is a list of access control entries (ACEs), wherein each ACE indicates a type of access that a given users has for the given resource, wherein each ACL comprises a unique ACL identifier (ACLid) for the given resource, wherein the one or more resources are organized in a hierarchical tree structure comprising one or more parent resources and one or more corresponding child resources, wherein an ACE of a given parent resource is visible to the corresponding child resources, and wherein the one or more resources comprise data, a file, or an object;
receive a new ACE for a parent resource;
compute a new ACL and corresponding ACLid for the parent resource;
update the table with the new ACL, new ACLid, new ACE, and an indication that the new ACL corresponds to an old ACL for the parent resource; and
update a current ACL associated with a child resource corresponding to the parent resource, the current ACL updating comprising:
determining whether one of the one or more old ACLs associated with the child resource corresponds to the new ACL of the parent resource;
if one of the one or more old ACLs corresponds to the current ACL, associating the corresponding new ACL with the child resource, wherein the current ACL updating further comprises receiving a new ACE for the child resource; and
if one of the one or more old ACLs in the table does not match the current ACL, computing a new ACL for the child resource and adding an entry to the table that maps the current ACL with the new ACL.
